(19) United States
(12) Patent Application Publication
(10) Pub. No.: US 2021/0181059 A1
(43) Pub. Date: Jun. 17, 2021

(54) BIPOLAR CYCLIC CODING FOR BRILLOUIN OPTICAL TIME DOMAIN ANALYSIS

(71) Applicant: NEC Laboratories America, Inc., Princeton, NJ (US)

(72) Inventors: Jian FANG, Princeton, NJ (US); Yaowen LI, Princeton, NJ (US); Ting WANG, West Windsor, NJ (US)

(73) Assignee: NEC LABORATORIES AMERICA, INC, Princeton, NJ (US)

(21) Appl. No.: 17/115,651

(22) Filed: Dec. 8, 2020

Related U.S. Application Data
(60) Provisional application No. 62/947,168, filed on Dec. 12, 2019.

(51) Int. Cl. G01M 11/00; G02B 6/02

(52) U.S. Cl. CPC G01M 11/3118; G02B 6/02; G01M 11/3145

(57) ABSTRACT

Aspects of the present disclosure describe systems, methods and structures providing bipolar cyclic coding for Brillouin optical time domain analysis that may be employed—for example—to determine high accuracy temperature and/or strain measurements along an optical fiber. Systems, methods, and structures according to the present disclosure employ the bipolar cyclic coding technique that advantageously overcomes the problems that plague the prior art and provides extended sensing range resulting from superior signal-to-noise characteristics.

### CROSS REFERENCE

This disclosure claims the benefit of U.S. Provisional Patent Application Ser. No. 62/947,168 filed Dec. 12, 2019 the entire contents of each incorporated by reference as if set forth at length herein.

### TECHNICAL FIELD

This disclosure relates generally to distributed optical fiber sensing systems, methods, and structures. More particularly, it describes a bipolar cyclic coding technique for Brillouin optical time domain analysis.

### BACKGROUND

Distributed optical fiber sensing and more particularly, Brillion-based distributed fiber sensing systems including Brillouin Optical Time Domain Analysis (BOTDA), have justifiably attracted great attention for their capability to provide high accuracy measurements of temperature or strain.

As is known, sensing performance of BOTDA, including the spatial resolution and measurement accuracy, depends on the signal-to-noise ratio (SNR) along the length of the fiber. However, a maximal injected optical power is fundamentally limited by fiber attenuation, modulation instability, stimulated Raman scatting, self-phase modulation and non-local effects. Therefore, for extended sensing range and the dynamic measurement applications, an SNR improvement is highly desirable.

Similar to traditional OTDR, pulse coding techniques have been introduced to BOTDA to improve the SNR. However, the non-return-to-zero (NRZ) Simplex coding has shown distorted results, due to the fact that the excited acoustic wave that interacts with each pulse depends on its previous values in the code word. Therefore, the multi-pulse response of the coded pulses is not the linear superposition of the corresponding single-pulse response, which violates requirements for decoding.

To enhance the SNR and solve the problem described above, the return-to-zero (RZ) coding technique has been proposed by M. Taki, Y. Muanenda, C. J. Oton, T. Nannipieri, A. Signorini, and F. DiPasquale in an article entitled “Cyclic pulse coding for fast BOTDA fiber sensors,” which appeared in Opt. Lett., 38(15), 2877 in 2013. In this paper, a low-repetition-rate cyclic coding was utilized, in which spacing between adjacent pulses are sufficiently longer than decay time of the acoustic wave. While a coding gain of 10 dB was successfully experimental demonstrated with 511-bit cyclic coding over 10 km distance by these authors, there are several limitations of this technique: First, for an L-bit code length, only (L+1)/2 bits are encoded as “1”s, which are filled by optical pulses, while the remaining (L−1)/2 bits are encoded as “0”s, which are left as no pulse. What this generally means that the coding gain is fundamentally limited to (L+1)/(2\sqrt{L}). Second, the modulated pump pulses are usually amplified by erbium doped fiber amplifier (EDFA) before launching into the fibers. However, the non-equidistant pulse distribution will encounter with gain distortion problem, which violates the requirement for perfect decoding that all coded pump powers have the identical optical power. To reduce such detrimental gain distortion, the EDFA gain has to be restricted. These limitations result in a trade-off between input power and system performance.

### SUMMARY

The above limitations are overcome and advance in the art is made according to aspects of the present disclosure directed to a novel bipolar cyclic coding technique for Brillouin Optical Time Domain Analysis (BOTDA)

### BRIEF DESCRIPTION OF THE DRAWING

A more complete understanding of the present disclosure may be realized by reference to the accompanying drawing in which:

FIG. 1 is a schematic diagram illustrating Prior Art non-uniform gain due to EDFA effect;

FIG. 2 is a schematic diagram illustrating uniform gain of bipolar cyclic coding after EDFA according to aspects of the present disclosure;

FIG. 3 is a plot illustrating calculated coding gain of bipolar cyclic coding and conventional cyclic coding according to aspects of the present disclosure;

FIG. 4 is a schematic diagram illustrating an experimental setup according to aspects of the present disclosure;

FIG. 5(A) and FIG. 5(B) are plots illustrating results after decoding with L=127-bit bipolar coding in which: FIG. 5(A) shows Brillouin gain spectrum along a 20-km sensing fiber; and FIG. 5(B) shows BOTDA trace at Brillouin frequency with and without bipolar cyclic coding respectively, according to aspects of the present disclosure;

The illustrative embodiments are described more fully by the Figures and detailed description. Embodiments according to this disclosure may, however, be embodied in various forms and are not limited to specific or illustrative embodiments described in the drawing and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we again note that similar to traditional OTDR, pulse coding techniques have been introduced to BOTDA to improve the SNR. However, the non-return-to-zero (NRZ) Simplex coding has shown distorted results, due to the fact that the excited acoustic wave that interacts with each pulse depends on its previous values in the code word. Therefore, the multi-pulse response of the coded pulses is not the linear superposition of the corresponding single-pulse response, which violates requirements for decoding.

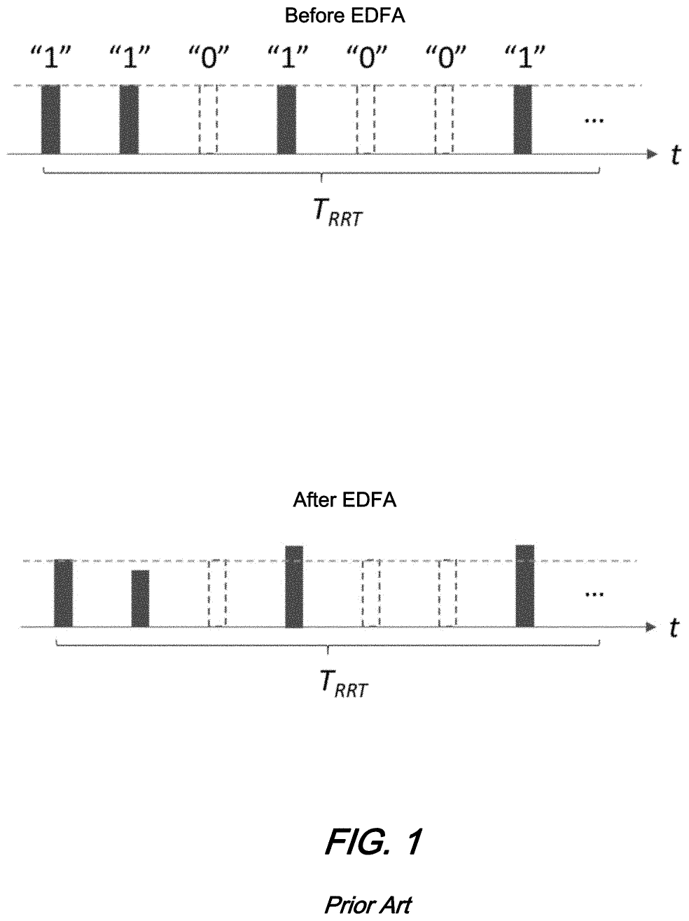

To enhance the SNR and solve the problem described above, the return-to-zero (RZ) coding technique has been proposed by M. Taki, Y. Muanenda, C. J. Oton, T. Nannipieri, A. Signorini, and F. DiPasquale in an article entitled “Cyclic pulse coding for fast BOTDA fiber sensors,” which appeared in Opt. Lett., 38(15), 2877 in 2013. In this paper, a low-repetition-rate cyclic coding was utilized, in which spacing between adjacent pulses are sufficiently longer than decay time of the acoustic wave. While a coding gain of 10 dB was successfully experimental demonstrated with 511-bit cyclic coding over 10 km distance by these authors, there are several limitations of this technique: First, for an L-bit code length, only (L+1)/2 bits are encoded as “1”s, which are filled by optical pulses, while the remaining (L−1)/2 bits are encoded as “0”s, which are left as no pulse. What this generally means that the coding gain is fundamentally limited to (L+1)/(2\sqrt{L}). FIG. 1 (Before EDFA—upper) shows an example of 7-bit cyclic coding scheme, where the codeword c=[1,1,0,1,0,0,1]. While the codeword has seven bits, only four bits are encoded with optical pulses while the remaining three bits are left blank.

Second, the modulated pump pulses are usually amplified by erbium doped fiber amplifier (EDFA) before launching into the fibers. However, the non-equidistant pulse distribution will encounter with gain distortion problem, which violates the requirement for perfect decoding that all coded pump powers have the identical optical power. As shown in FIG. 1 (After EDFA—lower), after EDFA amplification, the 7-bit cyclic coded pulses have non-uniform peak power. To reduce such detrimental gain distortion, the EDFA gain has to be restricted. These limitations result in a trade-off between input power and system performance.

Principle of the Bipolar Cyclic Coding

In this disclosure, we describe and demonstrate a novel bipolar cyclic coding technique for BOTDA sensors. The principle for this kind of bipolar coding is based on the fact that: for a cyclic codeword, such as a Simplex cyclic codeword containing “1” and “0” elements, its coding matrix is a Toeplitz matrix, in which each row is the cyclic shift of the previous row. Interestingly, its inverse matrix, which is called decoding matrix, is also a Toeplitz matrix containing elements of “1” and “−1”. For example, the 7-bit cyclic codeword c₇=[1,1,0,1,0,0,1] forms a coding matrix S₇ and its decoding matrix R₇ that:

$$\begin{matrix}{S}_{7} = [ \begin{matrix}1 & 1 & 0 & 1 & 0 & 0 & 1 \\ 1 & 1 & 1 & 0 & 1 & 0 & 0 \\ 0 & 1 & 1 & 1 & 0 & 1 & 0 \\ 0 & 0 & 1 & 1 & 1 & 0 & 1 \\ 1 & 0 & 0 & 1 & 1 & 1 & 0 \\ 0 & 1 & 0 & 0 & 1 & 1 & 1 \\ 1 & 0 & 1 & 0 & 0 & 1 & 1\end{matrix} ] , & ( 1 ) \\ {R}_{7} = {S}_{7}^{- 1} = \frac{1}{4} [ \begin{matrix}1 & 1 & - 1 & - 1 & 1 & - 1 & 1 \\ 1 & 1 & 1 & - 1 & - 1 & 1 & - 1 \\ - 1 & 1 & 1 & 1 & - 1 & - 1 & 1 \\ 1 & - 1 & 1 & 1 & 1 & - 1 & - 1 \\ - 1 & 1 & - 1 & 1 & 1 & 1 & - 1 \\ - 1 & - 1 & 1 & - 1 & 1 & 1 & 1 \\ 1 & - 1 & - 1 & 1 & - 1 & 1 & 1\end{matrix} ] = \frac{1}{4} {P}_{7} , & ( 1 )\end{matrix}$$

indicating that the bipolar coding matrix P₇ is also invertible, and its inverse matrix is exactly 4S₇. Thus, one column (or row) of the bipolar coding matrix P₇ can be used as the bipolar cyclic codeword. For example, the first column of P₇ can be chosen as the codeword d₇=[1,1, −1,1, −1, −1,1], which is equivalent to replacing the “0”s in c₇ by “−1”s.

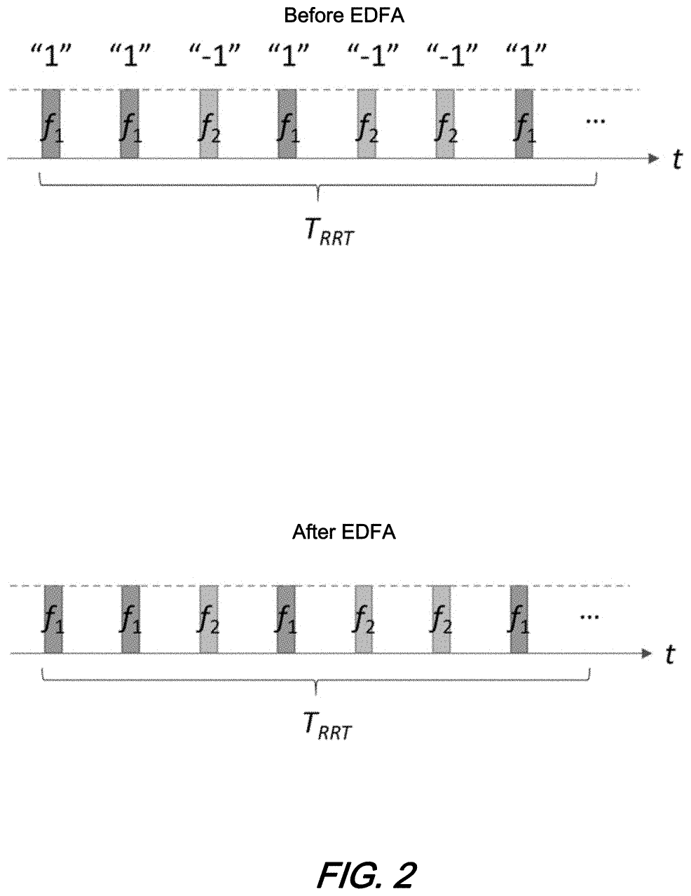

In a BOTDA system which is based on Stimulated Brillouin Scattering (SBS), the bipolar coding can be realized through the Brillouin gain (“+1”) and Brillouin loss (“−1”) process. In the encoding stage, the pump light has two different frequencies (f₁=f₀+f_{B} and f₂=f₀−f_{B}). If one bit of the bipolar codeword is “1”, the higher frequency will be encoded with an optical pulse. If one bit of the bipolar codeword is “−1”, the lower frequency will be encoded with an optical pulse. Since all bits are encoded with optical pulses, the coded pump pulse is evenly and equidistantly distributed on the whole round-trip time. As shown in FIG. 2 (Before EDFA—upper), the “+1” s in the bipolar codeword d₇ are encoded on the pump frequency f₁, and “−1”s are encoded on pump frequency f₂. This unique feature guarantees that after EDFA amplification, each pulse will have the same power, resulting in a flat gain even at a high pump power which breaks one of the limitations of conventional cyclic coding.

In the measurement stage, the probe wave is fixed at the frequency f₀, and the pump light is scanning the frequency of f_{B} and recorded the measured trace at each frequency. In the decoding stage, each measured trace of a scanned frequency will be decoded through the standard cyclic decoding process. After decoding all the traces of scanned frequencies, the 2-dimensional Brillouin gain spectrum will be reconstructed. The 2-D Brillouin gain spectrum will be used to estimate the Brillouin frequency shift, which is linear to the physical values such as temperature or strain.

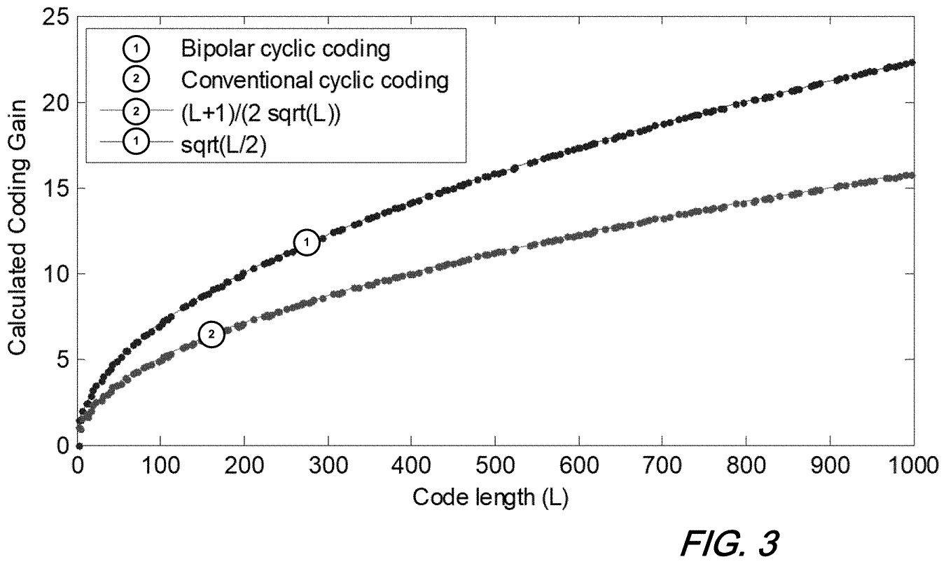

FIG. 3 is a plot that shows the coding gain comparison between the conventional cyclic coding and the proposed bipolar cyclic coding, for all prime numbers less than 1000. The coding gain of this bipolar is \sqrt{L/2}, which is higher than the coding gain (L+1)/(2\sqrt{L}) of the conventional cyclic coding method. This total coding gain improvement is equivalent to a 3-dB SNR enhancement, or a 50% reduction of the average time

### EXPERIMENTAL

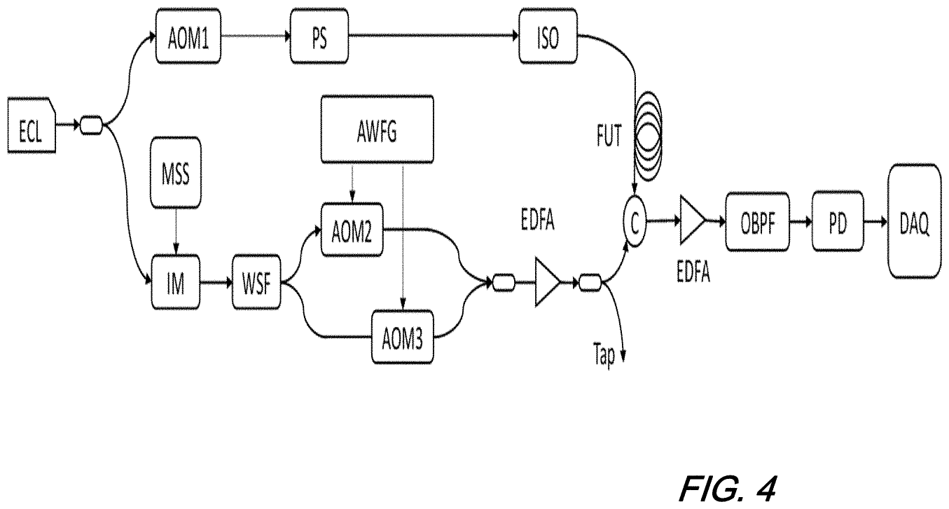

A schematic diagram of an illustrative experimental setup according to aspects of the present disclosure is shown in FIG. 4. An external cavity laser (ECL) with 10 kHz linewidth is split into two branches as the probe and the pump by a 3-dB beam splitter. The probe part passes through an acoustic-optic modulator (AOM1) first, which shift the probe frequency by 200 MHz, then through a polarization scrambler (PS) to eliminate the polarization effect. The pump part is first double-sideband modulated by a high extinction ratio intensity modulator (IM) driven by a microwave signal synthesizer (MSS) to generate a carrier-suppressed double sideband (DSB) wave. The lower sideband (LSB) and upper sideband (USB) pump wave are separated by a wavelength-selective filter (WSF). Then each sideband is encoded with pulses through AOM2 and AOM3 by an arbitrary waveform function generator (AWFG). The two encoded sideband are combined in beam combiner, and then amplified by an erbium-doped fiber amplifier (EDFA) to the desired power level. A small portion of the amplified power is monitored by a tap after the EDFA. The modulated pump pulses is injected into the fiber under test (FUT), which is a 20 km single-mode fiber spool via optical circulator (C). The probe wave interacts with the pump through counter propagation in the FUT, amplified by another EDFA followed by an optical band-pass filter (OBPF), and finally received by a photodetector (PD). The detected trace is recorded by a data acquisition (DAQ) device.

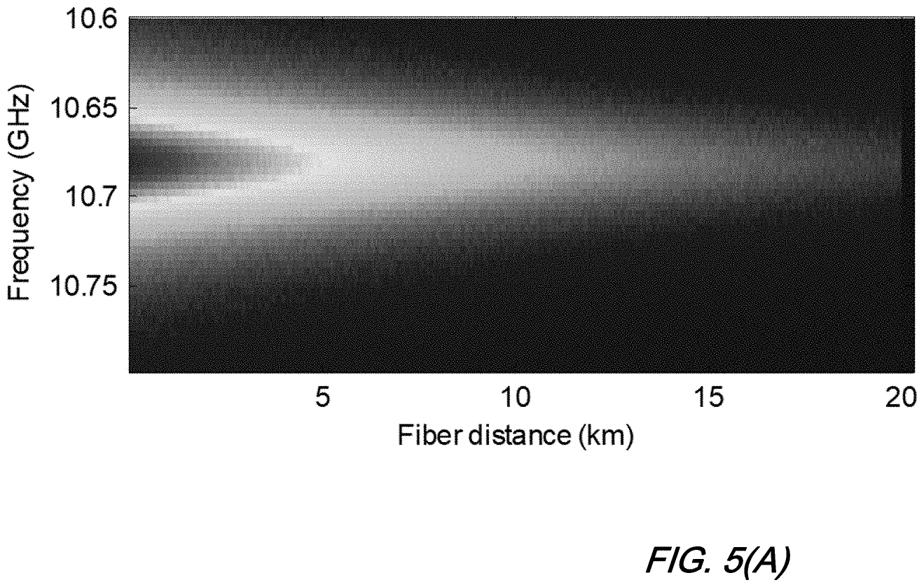

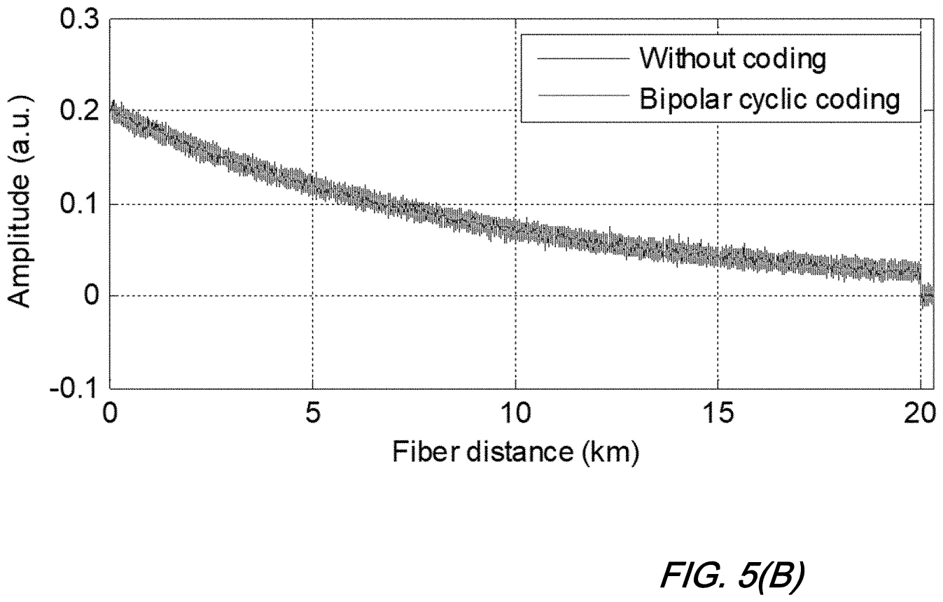

FIG. 5(A) is a plot showing the distributed Brillouin gain spectrum (BGS) after decoding with 127-bit bipolar cyclic codeword. The original Brillouin gain spectrum has been successfully reconstructed, which can be used for Brillouin frequency estimation and temperature/strain measurement. Thanks to the equaldistant distribution of pump pulses, the decoded trace is distortion free, and perfectly represent the shape of the Brillouin spectrum. FIG. 5(B) is a plot that depicts the trace at the Brillouin central frequency. It is clear shown that the noise reduction effected brought by the bipolar coding technique, compared with the trace obtained without coding. The measured coding gain is 7.81, which is in a good agreement with the theoretical coding gain 7.96 for a 127-bit code length. This is obviously higher than the theoretical coding gain of the conventional cyclic coding technique, which is 5.67 for 127-bit code length.

As a summary, this paper proposed a novel bipolar cyclic coding technique for BOTDA sensors. The bipolar cyclic codeword with “1” and “−1” can be easily generated through the existing cyclic codeword, and realized through the Brillouin gain and Brillouin loss process. Successful decoding and reconstruction of BOTDA traces have been demonstrated over 20 km standard single mode fiber. The encoded pump pulses distribute evenly and equaldistantly over the round-trip time window, making all the pulses keep the identical power for perfect distortion-free decoding. The coding gain of this technique is much higher than the conventional method, indicating that it has a promising application in the high-performance BOTDA sensors

At this point, while we have presented this disclosure using some specific examples, those skilled in the art will recognize that our teachings are not so limited. Accordingly, this disclosure should only be limited by the scope of the claims attached hereto.

1. A Brillouin Optical Time Domain Analysis (BOTDA) method for an optical fiber under test (FUT), the method comprising:
introducing optical probe pulses into the FUT;
introducing pump pulses into the FUT; and
detecting and analyzing interactions between the probe pulses and the pump pulses;
THE METHOD CHARACTERIZED BY:
bipolar cyclic coding of a bipolar codeword such that all resulting bits are encoded with an optical pulse.

2. The method of claim 1 FURTHER CHARACTERIZED BY:
the pump pulses comprise two frequencies f₁ and f₂

3. The method of claim 2 FURTHER CHARACTERIZED BY:
if a bit of the bipolar codeword is “1”, then f₁ is encoded with an optical pulse representative of the bit and if the bit of the bipolar codeword is “−1”, then f₂ is encoded with an optical pulse representative of the bit.

4. The method of claim 3 FURTHER CHARACTERIZED BY:
the coded pump pulse is evenly and equidistantly distributed on an entire round-trip of the optical fiber.

5. The method of claim 4 FURTHER CHARACTERIZED BY:
each pulse encoded in f₁ and f₂ will exhibit equal power after amplification by an erbium doped optical amplifier (EDFA) positioned in an optical path of the pulses.
